(19) United States
(12) Patent Application Publication
(10) Pub. No.: US 2008/0056867 A1
(43) Pub. Date: Mar. 6, 2008

(54) COMPUTER SERVER LIFT WITH SLIDEABLE HORIZONTAL SURFACE

(76) Inventor: Raymond S. Zuckerman, Scottsdale, AZ (US)

Correspondence Address: WEISS & MOY PC, 4204 NORTH BROWN AVENUE, SCOTTSDALE, AZ, 85251, US

(21) Appl. No.: 11/470,318

(22) Filed: Sep. 6, 2006

(51) Int. Cl. B60P 3/00

(52) U.S. Cl. 414/458

(57) ABSTRACT

A device for lifting, lowering, and mounting rack-mounted equipment has an “L” shape frame. A platform is vertically movable in a vertical member of the “L” shaped frame. The platform has a horizontally movable top surface. A plurality of wheels is coupled to a bottom surface of the “L” shaped frame. A lifting mechanism is coupled to the platform for moving the platform vertically in the vertical member of the “L” shaped frame. A stabilizer unit is coupled to the bottom surface of the “L” shaped frame.

### FIELD OF INVENTION

This invention relates generally to lifting devices and, more specifically, to a server lift designed to facilitate the process of lifting, lowering, and mounting rack-mounted computer servers and the like.

### BACKGROUND OF THE INVENTION

Often, when a computer server installation contains many separate servers, the servers are stored in a rack mount system. A rack system looks like a series of cabinets arranged in horizontal rows and vertical columns in which servers are stored on rails. The cabinets themselves may be 7 ft tall or higher in some instances.

A computer server tends to be heavier than standard computers and can easily weigh over 50 lbs. In large server installations, a technician may need to continuously retrieve and replace servers. Because server cases are so heavy and have many sharp edges, it can be difficult and dangerous for workers to load the servers into a cabinet. If a server were to fall onto someone from the top of a cabinet serious injury would result.

Currently, server-lifting devices do exist. However, current server-lifting devices fail to provide features necessary for their efficient and easy operation. For example, existing server lifts only have one set of control buttons which are centrally located on a control panel in the middle of the server lift. The presence of only one set of centrally located control buttons makes it difficult for the operator to use the server lift to properly align and access the rack mounts. This is due to the fact that the server lift generally blocks the view of the operator. The operator must bend around the server lift to properly align the lift surface to the rack mounts. Additionally, existing server lifts do not provide both precise control over the lift surface and rapid movement of the lift surface over large distances. Present server lifts only have a single operating speed. In short, the prior art server lifts disclose a set of devices that do not address the difficulties of operating in a confined area that requires precise control of the lifting device.

Therefore, a need exists to provide a server lift that overcomes the problems associated with prior art server lifts. The improved server lift needs to provide an easily observable slideable lift surface. The improved server lift needs to provide conveniently located control buttons. The improved server lift further needs to provide precise control and rapid movement of the lift surface.

### SUMMARY OF THE INVENTION

In accordance with one embodiment of the present invention, it is an object of the present invention is to provide an improved server lift that overcomes the problems associated with prior art server lifts.

It is another object of the present invention to provide a server lift that facilitates the process of installing and removing computer servers into and out of a rack mount system.

It is another object of the present invention is to provide a server lift having an easily observable sliding lift surface.

It is yet another object of the present invention is to provide a server lift having conveniently located control buttons.

It is still another object of the present invention is to provide precise control and rapid movement of the lift surface.

### BRIEF DESCRIPTION OF THE EMBODIMENTS

In accordance with one embodiment of the present invention, a device for lifting, lowering, and mounting rack-mounted equipment is disclosed. The device has an “L” shape frame. A platform is vertically movable in a vertical member of the “L” shaped frame. The platform has a horizontally movable top surface. A plurality of wheels is coupled to a bottom surface of the “L” shaped frame. A lifting mechanism is coupled to the platform for moving the platform vertically in the vertical member of the “L” shaped frame. A stabilizer unit is coupled to the bottom surface of the “L” shaped frame.

In accordance with one embodiment of the present invention, a device for lifting, lowering, and mounting rack-mounted equipment is disclosed. The device has an “L” shape frame comprising a base unit and a vertical member coupled to the base unit. The vertical member has a channeling to form a “U” shaped housing. A telescoping beam is coupled to an interior surface of the “U” shaped housing of the vertical member. The telescoping beam may be raised out of and lowered into the “U” shaped housing of the vertical member. A platform is vertically movable in the telescoping beam. The platform has a horizontally movable top surface. A lifting mechanism is coupled to the platform, the telescoping beam, and the interior surface of the vertical member of the “L” shaped frame. The lifting mechanism is used for moving the platform vertically in the telescoping beam and to raise and lower the telescoping beam. A stabilizer unit is coupled to the bottom surface of the base unit. A plurality of wheels coupled to a bottom surface of the “L” shaped frame.

The foregoing and other objects, features, and advantages of the invention will be apparent from the following, more particular, descriptions of the preferred embodiments of the invention, as illustrated in the accompanying drawing.

### BRIEF DESCRIPTION OF THE DRAWINGS

FIG. 1 is a perspective view of the server lift device of the present invention.

FIG. 2 is a perspective view of the server lift device of FIG. 1, showing the slideable surface partially deployed.

FIG. 3 is a perspective view of the rear portion of the server lift device of FIG. 1, showing the control panel.

FIG. 4 is a magnified perspective view of the lower portion of the server lift device of FIG. 1, showing the stabilizing device retracted.

FIG. 5 is a magnified perspective view of the lower portion of the server lift device of FIG. 1, showing the stabilizing device deployed.

FIG. 6 is a magnified perspective view of the lower front portion of the server lift device of FIG. 1, showing the forward caster wheels and the wheel locking pins.

FIG. 7 is a cross-sectional top view of the server lift device of FIG. 1, showing the vertical beam, telescoping beam and pulley slide.

FIG. 8 is a perspective view of the server lift device of FIG. 1, showing the telescoping beam extended.

FIG. 9 is a cross sectional side view of the server lift device of FIG. 1.

Common reference numerals are used throughout the drawings and detailed description to indicate like elements.

### DETAILED DESCRIPTION OF THE DRAWINGS

As shown in the Figures for purposes of illustration, the present invention is concerned with a server lift, generally designated in the accompanying drawings by the reference number 10. The server lift 10 is designed to facilitate the process of lifting, lowering, and mounting rack-mounted equipment such as computer servers, uninterruptible power supplies (UPS), phone switching equipment, KBM switches, and the like.

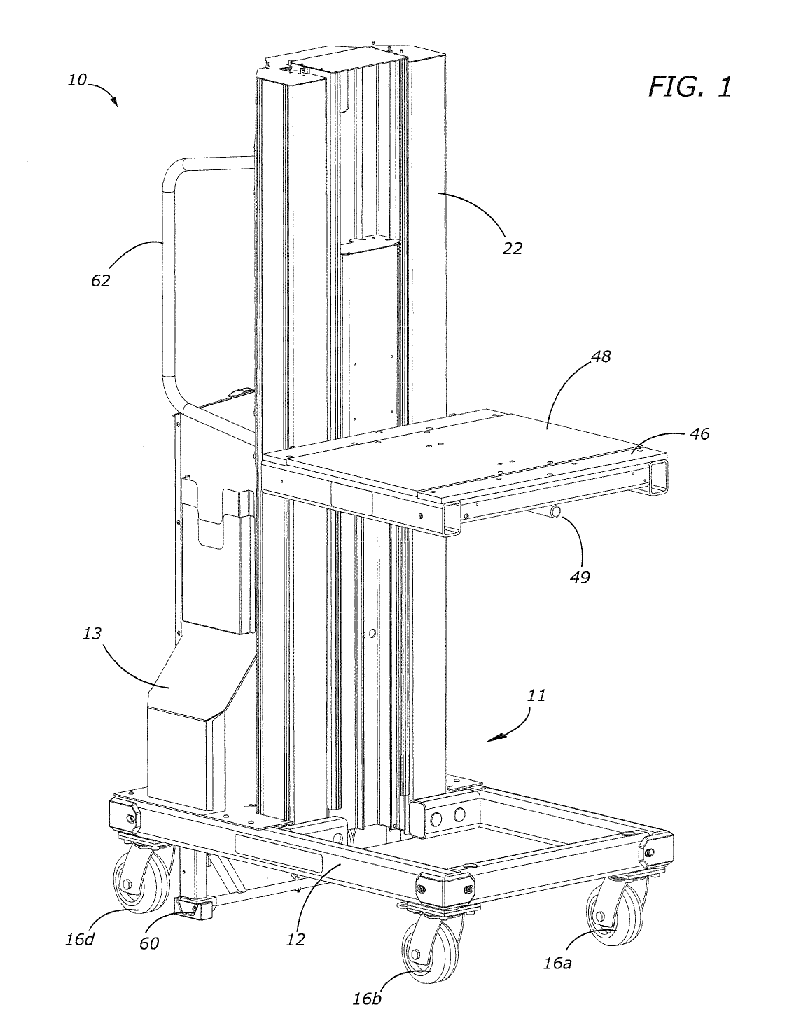

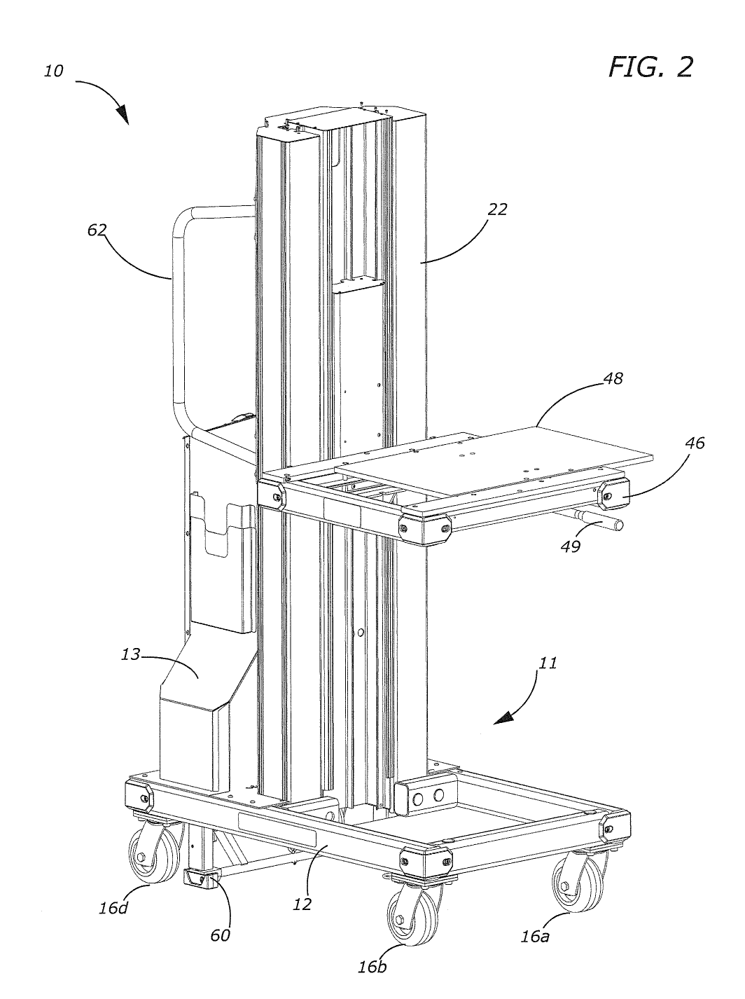

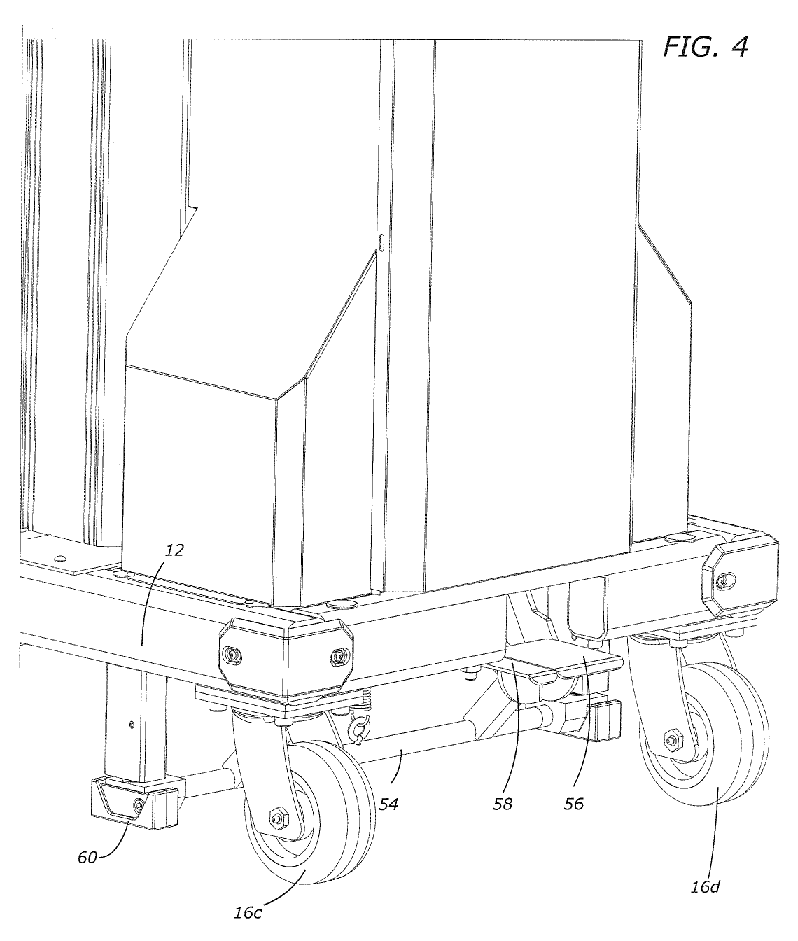

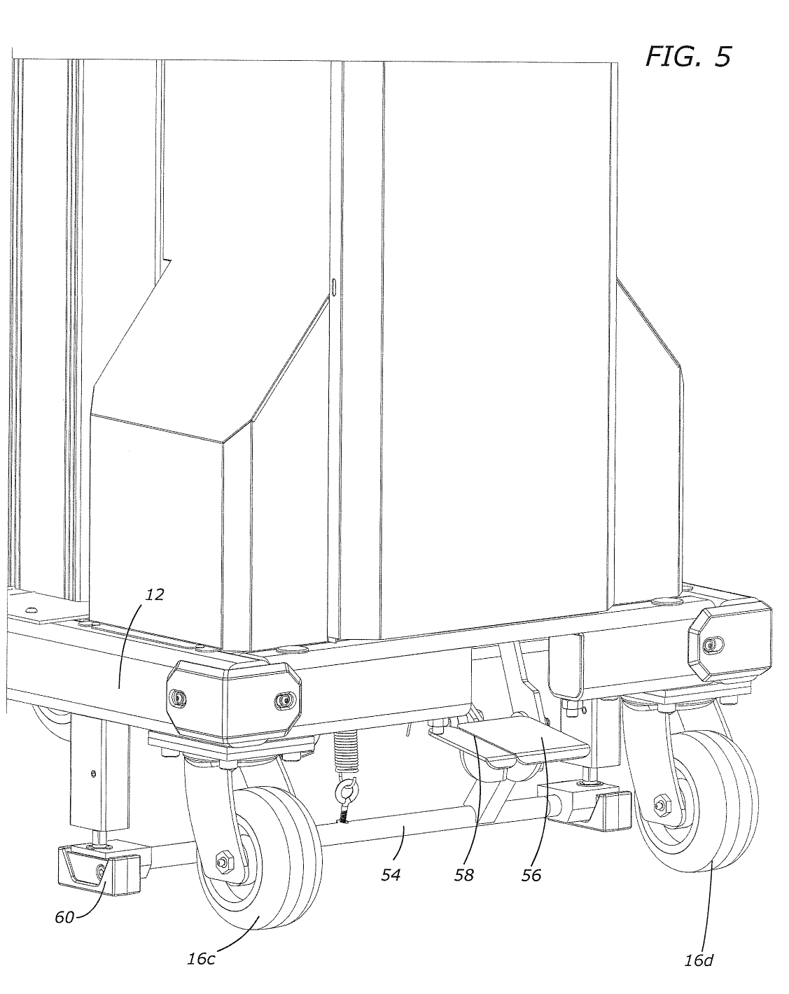

An embodiment of the server lift 10 is shown in FIGS. 1-9. The server lift 10 has a frame 11. The frame 11 is substantially L-shaped and can be constructed from any suitable material. In the preferred embodiment, the frame 11 is constructed from aluminum, however it should be clearly understood that the frame 11 may be made out of any other suitable material. The frame 11 has two sections, a base unit 12 and a vertical beam 22. The two sections, the base unit 12 and the vertical beam 22, may be formed out of the same piece of material, or they may be separate sections that are coupled together during the construction process.

The base unit 12 is preferably substantially rectangular in shape. However, the base 12 may be formed in some other shape without departing from the spirit and scope of the present invention. It is only necessary that the base unit 12 provide sufficient support for the server lift 10 that it may operate as a lifting device. In general, the base unit 12 lies substantially parallel to a ground surface. However, the server lift 10 may have a base unit 12 that does not lie substantially parallel to a ground surface. For example, the base unit 12 may slope up or down allowing wheels of different sizes to be placed at the front and the back of the server lift 10.

The bottom surface 14 of the base unit 12 is dimensioned to couple four wheels 16(a), 16(b), 16(c) and 16(d) thereto. In accordance with one embodiment of the present invention, the wheels 16(a), 16(b), 16(c) and 16(d) are caster wheels. The caster wheels will allow the server lift 10 to move in any direction in the X-Y plane.

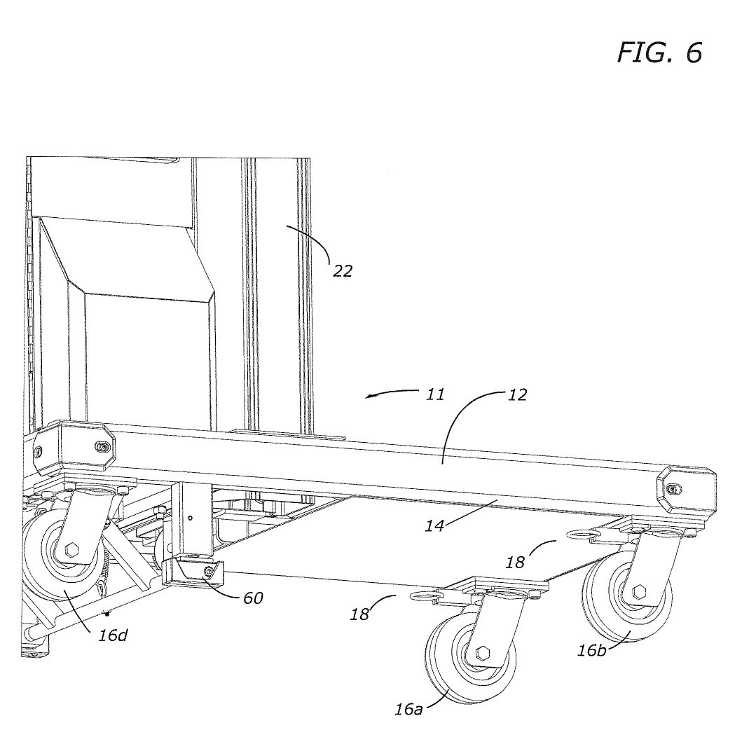

In accordance with one embodiment of the present invention, the front caster wheels 16(a) and 16(b) can be locked to prevent their rotation about the vertical axis with caster pins 18 (FIG. 6). The locking action allows a user to alter the way that the server lift 10 steers, possibly making it easier to navigate the server lift 10 to its destination. Although a preferred embodiment of the server lift 10 uses caster wheels 16(a), 16(b), 16(c), and 16(d) for transportation, a different embodiment may use an alternative method to allow movement. For example, bottom surface 14 of base unit 12 could be mounted to an air-cushion device similar to those found on hovercraft. Furthermore, a different embodiment may comprise a base unit 12 that provides no transportation mechanism. For example, server lift 10 could be placed on a ground surface where it could be used to raise and lower servers for a single cabinet without any need to be pushed to different locations. Also, for a server lift 10 that uses caster wheels 16(a), 16(b), 16(c), and 16(d), it should be noted that an alternative embodiment could be developed having no caster pins 18.

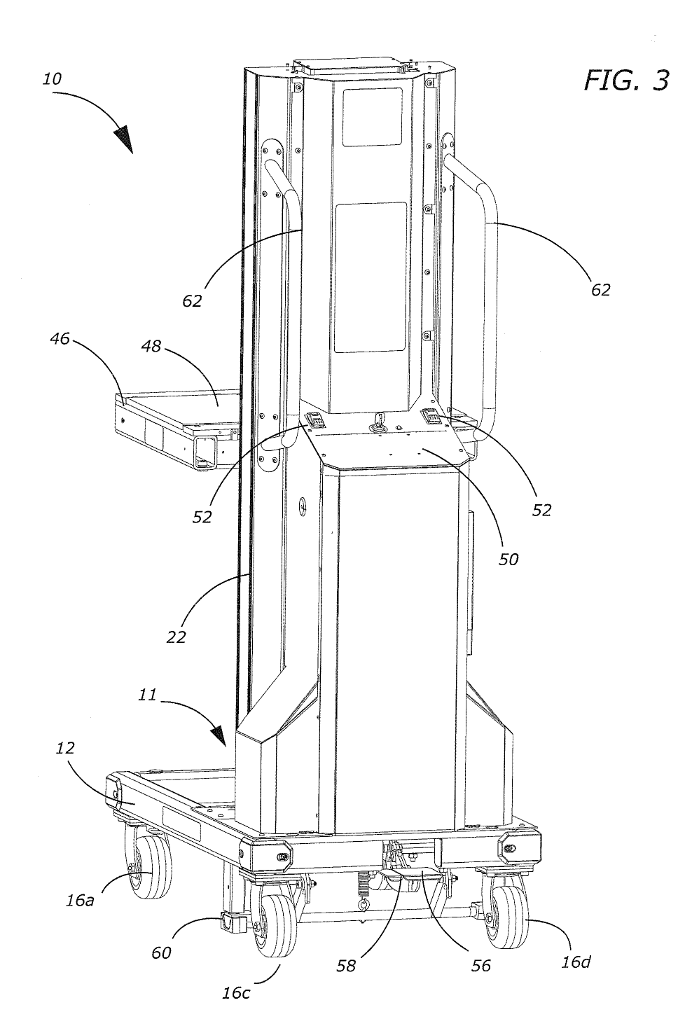

Base unit 12 houses a stabilizer system 54 (FIGS. 3-5). The stabilizer system 54 comprises an engaging foot pedal 56 and a disengaging foot pedal 58. When the engaging foot pedal 56 is depressed, stabilizing legs 60 extend downward and contact the floor. The foot pedal 56 will allow a user to adjust the level of pressure applied by the stabilizing legs 60. To retract the stabilizing legs 60, a user depresses the disengaging foot pedal 58. The stabilizer system 54 provides several advantages. First, by controlling the pressure on the stabilizing legs 60, the stabilizer system 54 acts as a braking system. The stabilizer system 54 further adds stability to the server lift 10. In the event that caster wheels 16 (a)-(d) rotate about their vertical axis and move the center of mass of the server lift 10s, the stabilizer system 54 will provided added stability by resetting the center of mass of the server lift 10 making lift operation safer. The stabilizer system 54 also acts as a brake to resist motion as servers are put on off the server lift.

While the embodiment in the Figures show a pair of stabilizing legs 60, it should be noted there may be more than two stabilizing legs 60 and the stabilizing legs 60 may be formed in different configurations with varying sizes and locations. It should also be noted that the stabilizing legs 60 could be deployed by different means. For example, instead of two pedals to raise and lower the stabilizing legs, one or more levers may be used to raise and lower the stabilizing legs. Alternatively, buttons could be added to control panel 50 that cause an electric motor to raise and lower them. Another possibility is that stabilizing legs 60 be automatically raised and lowered by a computer device when they are needed. Finally, it should be noted that an alternative embodiment of server lift 10 may not have stabilizing system 54.

The vertical beam 22 is coupled to base unit 12. The vertical beam 22 having a channel which runs a length of the vertical beam 22 to form a substantially “U” shape housing. In the interior section of the “U” shape housing of the vertical beam 22 is a telescoping beam 28. A plurality of cam followers 26 are coupled to an inner rear surface 24 of the vertical beam 22.

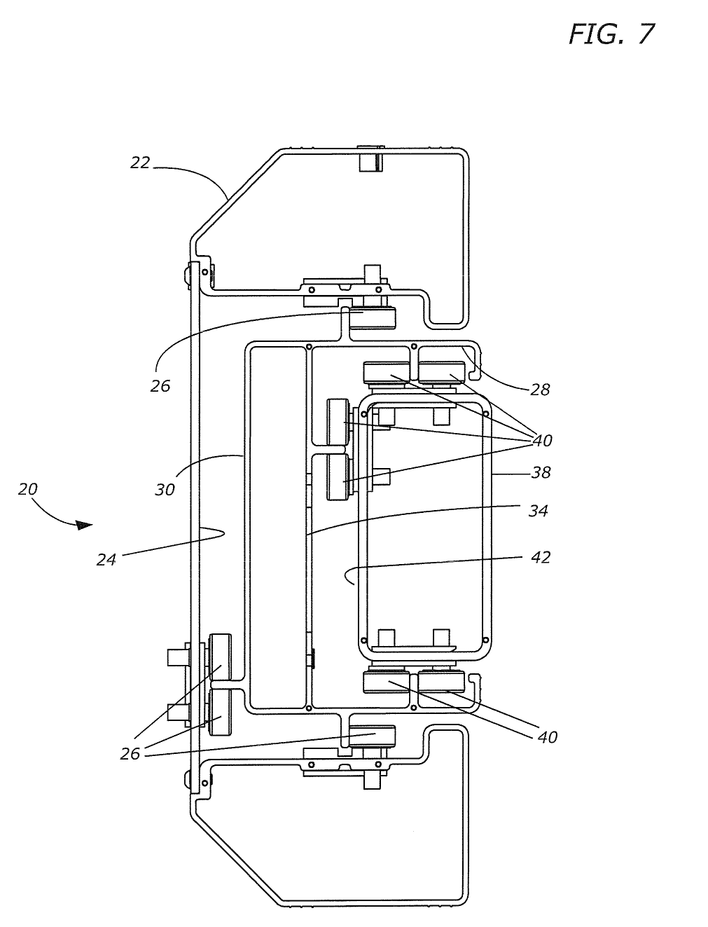

The telescoping beam 28 is dimensioned to fit inside the “U” shape housing of the vertical beam 22. The telescoping beam 28 is coupled to the vertical beam 22 by means of a plurality of ridges 32 and the corresponding cam followers 26. As shown in FIG. 7, the outside surface 30 of the telescoping beam 28 has a plurality of ridges 32 that run vertically along a length of the telescoping beam 28. The vertical ridges 32 are couple with a plurality of cam followers 26 that are coupled to the inner surface 24 of the vertical beam 22. The cam followers 26 allow the telescoping beam 28 to slide into and out of vertical beam 22. The telescoping beam 28 allows the server lift 10 to provide access to tall server cabinets while still maintaining a relatively low profile when all components are fully retracted. It should be noted that the server lift 10 could provide benefit to a user without the presence of telescoping beam 28.

A pulley slide 38 is coupled to telescoping beam 28 by means of a group of plurality of ridges 36 and cam followers 40. The inner surface 34 of the telescoping beam 28 has a plurality of ridges 36 that run vertically along a length of telescoping beam 28. The vertical ridges 36 are couple to the plurality of cam followers 40 that are coupled to the outer surface 42 of the pulley slide 38. The cam followers 40 allow the pulley slide 38 to slide up and down telescoping beam 28.

The combination of the plurality of ridges 32 and corresponding cam followers 26 that couple the vertical beam 22 to telescoping beam 28 and the plurality of ridges 36 and cam followers 40 that couple the telescoping beam 28 to the pulley slid 38 prevent those structures from rotating inside the vertical beam 22. This will lessen the torsional stress that may be applied on the vertical beam 22. Because the combination of ridges and cam followers prevent rotation, they add to the stability of the server lift 10, as well as to the controllability and safety of the server lift 10. It should be noted, however, that an alternative embodiment of the server lift 10 could be developed with a different design of ridges and cam followers. For example, a different number of ridges and cam followers could be used. Any structure that can be housed inside the vertical beam 22 and that prevents rotation of the telescoping beam 28 and the pulley slide 38 would be suitable for the server lift 10.

The pulley slide 38 is coupled to a horizontal surface 46. The horizontal surface 46 is substantially rectangular in shape (though other shapes could be used) and is preferably constructed from a rigid material such as steel. The horizontal surface 46 has a sliding surface 48 that can be slid out of the horizontal surface 46 to the left or to the right of the horizontal surface and away from a side of server lift 10. The sliding surface 48 allows a user to easily navigate the server lift 10 relatively close to a server cabinet and then extend the sliding surface 48 proximate to the server cabinet 10. Without the sliding surface 48, a user would have to negotiate the entire server lift proximate the server cabinet which may be very difficult as server lifts are relatively large and bulky and difficult to maneuver. Additionally, as the sliding surface 46 projects from the side of the server lift 10, its position can be seen by a user operating the server lift 10. This allows the user to more easily move the server lift 10 to line up the sliding surface 48 with the server cabinet shelf. A locking handle 49 is coupled to the horizontal surface 46. The locking handle 49 allows a user to lock the sliding surface 48 into place thereby minimizing the risk that the sliding surface 48 would change its position while the server lift 10 is being used.

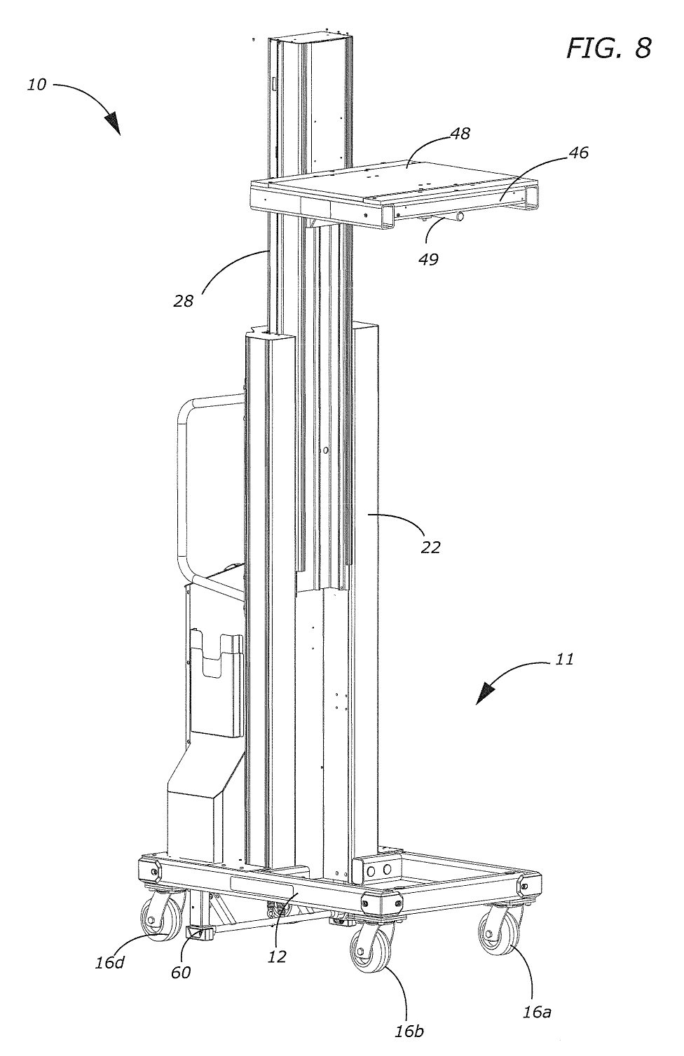

The server lift 10 uses a pulley system 44 to raise and lower the horizontal surface 46. The pulley system 44 is coupled to an electric motor 20, vertical beam 22, telescoping beam 28, and pulley slide 38. The pulley system 44 is centrally coupled to the vertical beam 22. This prevents torque and bending of the pulley system 44 when in use. In raising the horizontal surface 46, the electric motor 20 exerts force on the pulley system 44 which pulls the pulley slide 38 upwards along telescoping beam 28. As the pulley slide 38 gets higher, the telescoping beam 28 can extend from the vertical beam 22 allowing the horizontal surface 46 to be raised above the vertical beam 22 (FIG. 8). Conversely, as the electric motor 20 pays out the cable of the pulley system 44, gravity lowers the horizontal surface 46 and the telescoping beam 28 retracts into the vertical beam 22.

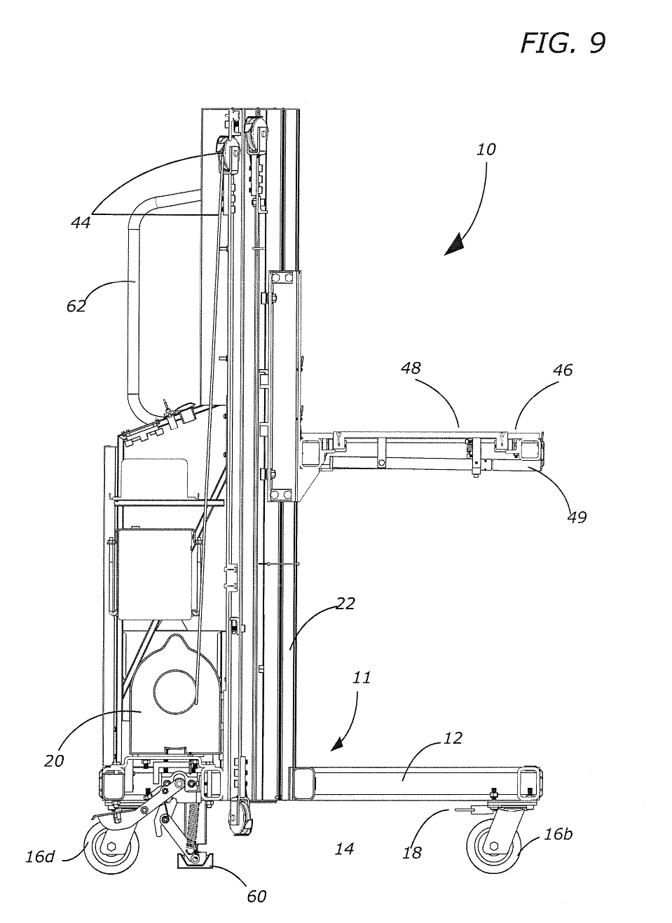

The electric motor 20 (FIG. 9) is coupled to the base unit 12. The electric motor 20 contains a speed control circuitry that allows for more precise control of the horizontal surface 46. The speed control circuitry of the electric motor 20 causes an initial movement of the horizontal surface 46 to take place slowly and with high precision. However, as the horizontal surface 46 continues to move in one direction it will accelerate at a faster speed until a maximum speed is reached. The electric motor 20 will then maintain this maximum speed. Although in the preferred embodiment electric motor 20 is coupled to base unit 12, it should be noted that electric motor 20 could be located elsewhere in server lift 10. For example, it could be located in vertical beam 22.

The server lift 10 is controlled through a control panel 50 (FIG. 3). Elevation controls 52 are coupled to the electric motor 20 and are provided on both side of the control panel 50. This allows a user on either side of server lift 10 to control the server lift 10. The presence of elevation controls 52 on both side of the control panel 50 makes it easier for the operator to use the server lift 10 to properly align and access the rack mounts. This is due to the fact that the server lift 10 will not block the view of the operator since the elevation controls 52 are on both side of the control panel 50. Thus, the operator no longer must bend around the server lift 10 to properly align the lift surface to the rack mounts.

The elevation controls 52 are generally toggle switches. By holding the toggle switch in one direction, the horizontal surface 46 will accelerate in that direction. Once the toggle switch is released, the horizontal surface 46 will stop. A single tab on the toggle switch will move the horizontal surface 46 incrementally in a respective direction. Thus, the elevation controls 52 allow for provide precise control and rapid movement of the horizontal surface 46.

Handles 62 are coupled to the vertical beam 22. The handles 62 allow a user to maneuver the server lift 10. It should be noted that additional handles could be located elsewhere on server lift 10 or, in fact, fewer handles could be located on server lift 10 without substantially changing the invention. The handles 62 allow a user to push, pull, or turn the server lift 10 in a desired direction.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A device for lifting, lowering, and mounting rack-mounted equipment comprising:
an “L” shape frame;
a platform vertically movable in a vertical member of the “L” shaped frame, the platform having a horizontally movable top surface;
a plurality of wheels coupled to a bottom surface of the “L” shaped frame;
a lifting mechanism coupled to the platform for moving the platform vertically in the vertical member of the “L” shaped frame; and
a stabilizer unit coupled to the bottom surface of the “L” shaped frame.

2. A device for lifting, lowering, and mounting rack-mounted equipment in accordance with claim 1 further comprising:
a telescoping beam coupled to an interior surface of the vertical member of the “L” shaped frame, the platform vertically movable in the telescoping beam;
wherein the lifting mechanism raises and lowers the telescoping beam.

3. A device for lifting, lowering, and mounting rack-mounted equipment in accordance with claim 2 further comprising:
a first set of ridges formed on an exterior surface of the telescoping beam and running vertically along a length of the telescoping beam; and
a first plurality of cam followers coupled to the interior surface of the vertical member of the “L” shaped frame, wherein at least one cam follower of the first plurality of cam followers is positioned on each side of each of the first set of ridges, the first plurality of cam followers allowing the raising mechanism to raise and lower the telescoping beam;
wherein the first set of ridges and the first plurality of cam followers preventing the telescoping beam from rotating in the vertical member of the “L” shaped frame.

4. A device for lifting, lowering, and mounting rack-mounted equipment in accordance with claim 3 further comprising:
a second set of ridges, the second set of ridges formed on an interior surface of the telescoping beam and running vertically along the length of the telescoping beam; and
a second plurality of cam followers, the second plurality of cam followers coupled to the lifting mechanism, wherein at least one cam follower of the second plurality of cam followers is positioned on each side of each of the second set of ridges, the second plurality of cam followers allowing the raising mechanism to raise and lower the platform;
wherein the second set of ridges and the second plurality of cam followers preventing the lifting mechanism from rotating in the telescoping beam.

5. A device to for lifting, lowering, and mounting rack-mounted equipment in accordance with claim 1 further comprising a plurality of handles coupled to the “L” shaped frame.

6. A device to for lifting, lowering, and mounting rack-mounted equipment in accordance with claim 1 further comprising a control panel coupled to the “L” shaped frame, the control panel having control devices coupled on both sides of the control panel for controlling the lifting mechanism.

7. A device to for lifting, lowering, and mounting rack-mounted equipment in accordance with claim 1 wherein the platform comprises:
a support structure vertically movable in a vertical member of the “L” shaped frame; and
a plate member slidably coupled to the support structure, the plate member sliding horizontally in the support structure to extend out from the support structure.

8. A device to for lifting, lowering, and mounting rack-mounted equipment in accordance with claim 7 further comprising a locking handle coupled to the support structure to lock the plate member in place.

9. A device to for lifting, lowering, and mounting rack-mounted equipment in accordance with claim 2 wherein the lifting mechanism comprises:
a pulley slide coupled to an interior surface of the vertical member of the “L” shaped frame and to the platform;
a pulley system coupled to the pulley slide, the telescoping beam, and the interior surface of the vertical member of the “L” shaped frame to raise and lower the platform and the telescoping beam; and
a motor coupled to the pulley system.

10. A device to for lifting, lowering, and mounting rack-mounted equipment in accordance with claim 1 further comprising locking pins coupled to the plurality if wheels.

11. A device to for lifting, lowering, and mounting rack-mounted equipment in accordance with claim 1 wherein the stabilizing unit comprises:
at least a pair of stabilizing legs retractably coupled to a bottom surface of the “L” shaped frame; and
deployment mechanism coupled to at least a pair of stabilizing legs and the “L” shaped frame for raising and lowering the stabilizing legs.

12. A device to for lifting, lowering, and mounting rack-mounted equipment in accordance with claim 9 wherein the pulley system centrally located on the vertical member of the “L” shaped frame to prevent torque and bending of the pulley system.

13. A device to for lifting, lowering, and mounting rack-mounted equipment in accordance with claim 9 wherein the motor has a first speed to move the platform with precision, and will accelerate at a faster speed until a maximum speed is reached.

14. A device to for lifting, lowering, and mounting rack-mounted equipment comprising:
an “L” shape frame comprising:
a base unit; and
a vertical member coupled to the base unit, wherein the vertical member has a channeling to form a “U” shaped housing;
a telescoping beam coupled to an interior surface of the “U” shaped housing of the vertical member, wherein the telescoping beam may be raised out of and lowered into the “U” shaped housing of the vertical member;
a platform vertically movable in the telescoping beam, the platform having a horizontally movable top surface;
a lifting mechanism coupled to the platform, the telescoping beam, and the interior surface of the vertical member of the “L” shaped frame for moving the platform vertically in the telescoping beam and to raise and lower the telescoping beam;
a stabilizer unit coupled to the bottom surface of the base unit; and
a plurality of wheels coupled to a bottom surface of the “L” shaped frame.

15. A device to for lifting, lowering, and mounting rack-mounted equipment in accordance with claim 14 further comprising:
a first set of ridges formed on an exterior surface of the telescoping beam and running vertically along a length of the telescoping beam; and
a first plurality of cam followers coupled to the interior surface of the vertical member of the “L” shaped frame, wherein one cam follower of the first plurality of cam followers is positioned on each side of each of the first set of ridges, the first plurality of cam followers allowing the raising mechanism to raise and lower the telescoping beam;
wherein the first set of ridges and the first plurality of cam followers preventing the telescoping beam from rotating in the vertical member of the “L” shaped frame.

16. A device to for lifting, lowering, and mounting rack-mounted equipment in accordance with claim 15 further comprising:
a second set of ridges, the second set of ridges formed on an interior surface of the telescoping beam and running vertically along the length of the telescoping beam; and
a second plurality of cam followers, the second plurality of cam followers coupled to the lifting mechanism, wherein one cam follower of the second plurality of cam followers is positioned on each side of each of the second set of ridges, the second plurality of cam followers allowing the raising mechanism to raise and lower the platform;
wherein the second set of ridges and the second plurality of cam followers preventing the lifting mechanism from rotating in the telescoping beam.

17. A device to for lifting, lowering, and mounting rack-mounted equipment in accordance with claim 14 further comprising a control panel coupled to the “L” shaped frame, the control panel having control devices coupled on both sides of the control panel for controlling the lifting mechanism.

18. A device to for lifting, lowering, and mounting rack-mounted equipment in accordance with claim 14 wherein the platform comprises:
a support structure vertically movable in the telescoping beam; and
a plate member slidably coupled to the support structure, the plate member sliding horizontally in the support structure to extend out from the support structure; and
a locking handle coupled to the support structure to lock the plate member in place.

19. A device to for lifting, lowering, and mounting rack-mounted equipment in accordance with claim 14 wherein the lifting mechanism comprises:
a pulley slide coupled to an interior surface of the vertical member of the “L” shaped frame and to the platform;
a pulley system coupled to the pulley slide, the telescoping beam, and the interior surface of the vertical member of the “L” shaped frame to raise and lower the platform and the telescoping beam; and
a motor coupled to the pulley system.

20. A device to for lifting, lowering, and mounting rack-mounted equipment in accordance with claim 14 wherein the stabilizing unit comprises:
at least a pair of stabilizing legs retractably coupled to a bottom surface of the “L” shaped frame; and
deployment mechanism coupled to at least a pair of stabilizing legs and the “L” shaped frame for raising and lowering the stabilizing legs.

21. A device to for lifting, lowering, and mounting rack-mounted equipment in accordance with claim 19 wherein the pulley system centrally located on the vertical member of the “L” shaped frame to prevent torque and bending of the pulley system.

22. A device to for lifting, lowering, and mounting rack-mounted equipment in accordance with claim 19 wherein the motor has a first speed to move the platform with precision, the motor will accelerate at a faster speed until a maximum speed is reached.
